(19) United States
(12) Patent Application Publication
(10) Pub. No.: US 2026/0319887 A1
(43) Pub. Date: Oct. 15, 2026

(54) APPARATUSES, SYSTEMS, AND METHODS FOR ECS ADDRESS GENERATION AND CONTROL

(71) Applicant: Micron Technology, Inc., Boise, ID (US)

(72) Inventors: Yang Lu, Boise, ID (US); David R. Brown, Allen, TX (US); Kang-Yong Kim, Boise, ID (US); Gary Howe, Allen, TX (US)

(73) Assignee: Micron Technology, Inc., Boise, ID (US)

(21) Appl. No.: 19/465,324

(22) Filed: Jan. 30, 2026

Related U.S. Application Data
(60) Provisional application No. 63/767,926, filed on Mar. 6, 2025.
(60) Provisional application No. 63/848,005, filed on Jul. 21, 2025.

(51) Int. Cl. G06F 11/10; G06F 12/02

(52) U.S. Cl. CPC G06F 11/106; G06F 12/0223; G06F 2212/1032

(57) ABSTRACT

A memory device includes a memory array organized into banks, with each bank including a number of rows, each of which stores a number of codewords. Over the course an error check and scrub (ECS) cycle, ECS addresses for each codeword are sequentially generated and each codeword is checked for errors and those errors are corrected. One or more ECS operations may be performed responsive to an ECS command. The ECS command may specify address information about where the ECS operation(s) should be performed.

### CROSS REFERENCE TO RELATED APPLICATION(S)

This application claims the benefit under 35 U.S.C. § 119 of the earlier filing date of U.S. Provisional Application Serial No. 63/767,926 filed Mar. 6, 2025 and U.S. Provisional Application No. 63/848,005 filed Jul. 21, 2025. The entire contents of both aforementioned applications are hereby incorporated by reference herein in their entirety for any purpose.

### BACKGROUND

This disclosure relates generally to semiconductor devices, such as semiconductor memory devices. The semiconductor memory device may include a number of memory cells which are used to store information. The stored information may be encoded as binary data, and each memory cell may store a single bit of the information. Information may decay or change in the memory cells due to a variety of different errors, which may lead to one or more bits of incorrect information (e.g., bits with different states that the bit which was originally written) being read out from the memory device.

There may be many applications where it is useful to ensure a high fidelity of information read out from the memory. Memory devices may include error correction circuits, which may be used to determine if the information read out of the memory cells contains any errors compared to the data written into the memory cells, and may correct discovered errors. The memory device may periodically use the error correction circuits to repair errors in information stored within the memory array by scanning every memory cell of the memory array as part of an error check and scrub (ECS) cycle.

### BRIEF DESCRIPTION OF THE DRAWINGS

FIG. 1 is a block diagram of a semiconductor device according some embodiments of the present disclosure.

FIG. 2 is a block diagram of bank access logic in a memory device according to some embodiments of the present disclosure.

FIG. 3 is a block diagram of ECS logic according to some embodiments of the present disclosure.

FIG. 4 is a timing diagram of ECS operations according to some embodiments of the present disclosure.

FIGS. 5A-5C are charts showing example ECS commands according to some embodiments of the present disclosure.

FIG. 6 is a mode register including ECS address information according to some embodiments of the present disclosure.

FIGS. 7A and 7B are example sequences of ECS operations according to some embodiments of the present disclosure.

FIG. 8 is a flow chart of a method of performing operations on a memory while performing ECS operations according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

A memory device may include a memory array which has a number of memory cells, each located at the intersection of a word line (row) and digit line (column). During a read or write operation, a row may be activated, and data may be read from, or written to, the memory cells along the activated row. Each row may include memory cells which store a number of bits of data and a number of bits of parity information (e.g., data bits and parity bits), which may be used to correct up to a certain number of errors in the data bits. For example, the memory cells along a row may be used to store one or more codewords, each of which includes J data bits and K parity bits, which may be used to correct some number of the bits of the codeword. For example, in a single error correction (SEC) device, up to one bit of the codeword may be corrected based on the parity bits by an error correction code (ECC) circuit. During a write operation the parity bits may be generated by the ECC circuit based on the data received and then the data and parity bits are written to the memory cells of the row. During a read operation the ECC circuit receives data and parity from the activated row and uses the parity bits to determine if one or more the read data bits are in error. Depending on the implementation, the ECC circuit may detect errors (e.g., by signaling that the codeword contains one or more errors), correct errors (e.g., by flipping the state of a bit where which is in error) or combination thereof.

The ECC circuit may identify errors in read data and correct the read data before it is provided to data terminals of the memory device. However, the error may remain in the codeword stored in the memory array since the ECC circuit corrects the error as it is being read out. The device may perform error check and scrub (ECS) operations to remedy this. In an ECS operation, the address of each codeword of the memory array may be accessed in a sequence. The codeword from the current ECS address is read out, an error, if present, is corrected by the ECC circuit, and then the corrected codeword is written back to the memory array. The memory performs an ECS cycle by performing ECS operations on each codeword of the memory by working through a sequence of every codeword address.

The memory device receives commands, such as manual ECS (MECS) commands, that cause it to perform ECS operations. The memory may generally expect to receive commands at an average rate based on the total number of commands per ECS cycle divided by the length of the ECS cycle. However, in conventional memory devices, how many ECS commands are required over the ECS cycle may be variable based on how many codewords there are. While the memory is performing ECS operations on a codeword in a bank, that bank (and any other banks that share certain circuits such as the ECC circuit) cannot be used for other purposes. However, the other banks of the memory may still be accessible. It may be useful to give the controller mechanisms to monitor and/or control which bank the ECS operation is being performed in, as well as unify ECS protocols across memory devices of the different size.

The present disclosure is directed to apparatuses, systems, and methods for ECS address generation and control. An example memory device includes a ECS logic circuit that performs ECS operations responsive to an ECS command (and/or to an auto-ECS signal generated by the memory in some modes). The memory device may have a size setting which indicates how many codewords are stored on the device. The size setting changes how many ECS operations are performed responsive to the ECS command. In this manner, the number of ECS commands per ECS cycle may remain constant across devices with different numbers of codewords. For example, a first device may have twice the codewords of a second device. The size setting of the first device causes 2 ECS operation to be performed per ECS command while the size setting of the second device causes 1 ECS operations to be performed per ECS command. Both complete their ECS cycles in a same number of ECS commands. This may alleviate the need for the controller (and/or auto-ECS logic) to change the rate at which ECS commands are generated between devices of different sizes.

An example memory device according to some embodiments of the present disclosure may be capable of performing an ECS operation on a first bank and leave other banks open to other operations, such as access operations. For example, when an ECS command is received, the memory may perform the ECS operation on a first bank, and still be able to perform access operations on a second bank.

An example memory device according to some embodiments of the present disclosure may receive ECS commands which specify a location of the ECS operation. For example, the ECS command may include information about the bank to have an ECS operation performed on it, the codeword to have an ECS operation performed on it, the row to have an ECS operation performed on it, the number of ECS operations to be performed responsive to the command, or combinations thereof. It may be useful for the controller to provide ECS commands which specify the bank, as that may help the controller keep track of which bank(s) are tied up performing an ECS operation, so that the controller may provide access commands to other banks.

An example memory device according to some embodiments of the present disclosure may include a mode register which stores one or more pieces of information about a current ECS address. Each time the ECS circuit performs an ECS operation, it updates the ECS address in the register. The controller may read the information from the ECS register in order to determine where the next ECS operation will be performed. In some embodiments, the controller may also write to the ECS register in order to control where the next ECS operation will be performed. In some embodiments, a register of the mode register or a command may be used to reset the counters which generate the ECS address.

An example memory device according to some embodiments of the present disclosure may generate ECS addresses using a set of counters, which together sequentially count through the address space. In some embodiments, the ECS addresses may count through all the codewords along a first row in a first bank, then all the codewords along a first row in a second bank, and so forth until all the banks have had an ECS operation performed on the codewords of their first rows and then begin performing ECS operations on the codewords of the second row of the first bank. In some embodiments, only a portion of the codewords along the first row may be refreshed as the banks are cycled through, then the remainder of the codewords along the first row in a second cycle of the banks, and then the row updated.

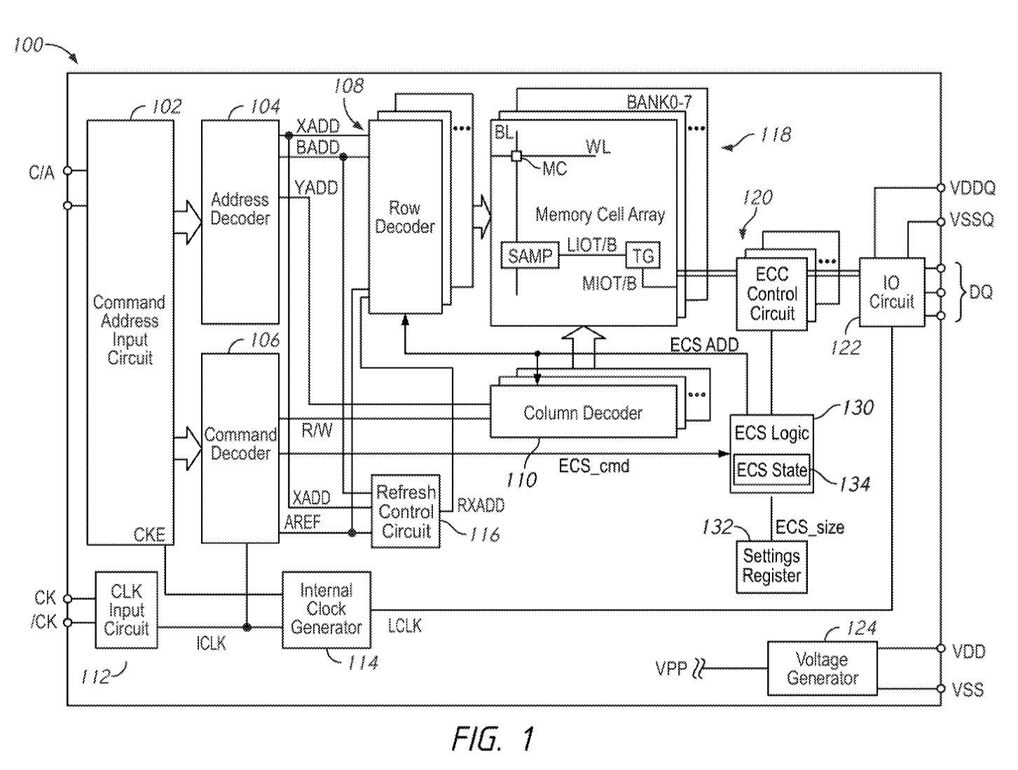

FIG. 1 is a block diagram of a semiconductor device according an embodiment of the disclosure. The semiconductor device 100 may be a semiconductor memory device, such as a DRAM device integrated on a single semiconductor chip.

The semiconductor device 100 includes a memory array 118. The memory array 118 is shown as including a plurality of memory banks. In the embodiment of FIG. 1, the memory array 118 is shown as including eight memory banks BANK0-BANK7. More or fewer banks may be included in the memory array 118 of other embodiments. Each memory bank includes a plurality of word lines WL, a plurality of bit lines BL, and a plurality of memory cells MC arranged at intersections of the plurality of word lines WL and the plurality of bit line BL. The selection of the word line WL is performed by a row decoder 108 and the selection of the bit lines BL is performed by a column decoder 110. In the embodiment of FIG. 1, the row decoder 108 includes a respective row decoder for each memory bank and the column decoder 110 includes a respective column decoder for each memory bank. The bit lines BL are coupled to a respective sense amplifier (SAMP). Read data from the bit line BL is amplified by the sense amplifier SAMP, and transferred to read/write amplifiers 120 over complementary local data lines (LIOT/B), transfer gate (TG), and complementary main data lines (MIOT/B) which are coupled to an error correction code (ECC) control circuit 120. Conversely, write data outputted from the ECC control circuit 120 is transferred to the sense amplifier SAMP over the complementary main data lines MIOT/B, the transfer gate TG, and the complementary local data lines LIOT/B, and written in the memory cell MC coupled to the bit line BL.

The semiconductor device 100 may employ a plurality of external terminals that include command and address (C/A) terminals coupled to a command and address bus to receive commands and addresses, and a CS signal, clock terminals to receive clocks CK and /CK, data terminals DQ to provide data, and power supply terminals to receive power supply potentials VDD, VSS, VDDQ, and VSSQ.

The clock terminals are supplied with external clocks CK and /CK that are provided to an input circuit 112. The external clocks may be complementary. The input circuit 112 generates an internal clock ICLK based on the CK and /CK clocks. The ICLK clock is provided to the command decoder 106 and to an internal clock generator 114. The internal clock generator 114 provides various internal clocks LCLK based on the ICLK clock. The LCLK clocks may be used for timing operation of various internal circuits. The internal data clocks LCLK are provided to the input/output circuit 122 to time operation of circuits included in the input/output circuit 122, for example, to data receivers to time the receipt of write data.

The C/A terminals may be supplied with memory addresses. The memory addresses supplied to the C/A terminals are transferred, via a command/address input circuit 102, to an address decoder 104. The address decoder 104 receives the address and supplies a decoded row address XADD to the row decoder 108 and supplies a decoded column address YADD to the column decoder 110. The address decoder 104 may also supply a decoded bank address BADD, which may indicate the bank of the memory array 118 containing the decoded row address XADD and column address YADD. The C/A terminals may be supplied with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

The commands may be provided as internal command signals to a command decoder 106 via the command/address input circuit 102. The command decoder 106 includes circuits to decode the internal command signals to generate various internal signals and commands for performing operations. For example, the command decoder 106 may provide a row command signal to select a word line and a column command signal to select a bit line.

The device 100 may receive an access command which is a write command. When the write command is received, and a bank address, a row address, and a column address are timely supplied as part of the write operation, and write data is supplied through the DQ terminals to the ECC control circuit 120. The write data supplied to the data terminals DQ is written to a memory cells in the memory array 118 corresponding to the row address and column address. The write command is received by the command decoder 106, which provides internal commands so that the write data is received by data receivers in the input/output circuit 122. Write clocks may also be provided to the external clock terminals for timing the receipt of the write data by the data receivers of the input/output circuit 122. The write data is supplied via the input/output circuit 122 to the ECC control circuit 120. The ECC control circuit 120 may generate a number of parity bits based on the write data, and the write data and the parity bits may be provided as a codeword to the memory array 118 to be written into the memory cells MC.

The device 100 may receive an access command which is a read command. When a read command is received, and a bank address, a row address and a column address are timely supplied with the read command, a codeword including read data and read parity bits is read from memory cells in the memory array 118 corresponding to the row address and column address. The read command is received by the command decoder 106, which provides internal commands so that read data from the memory array 118 is provided to the ECC control circuit 120. The ECC control circuit 120 may use the parity bits in the codeword to determine if the codeword includes any errors, and if any errors are detected, may correct them to generate a corrected codeword (e.g., by changing a state of the identified bit(s) which are in error). The corrected codeword (without the parity bits) is output to outside the device 100 from the data terminals DQ via the input/output circuit 122.

The ECC control circuit 120 may be used to ensure the fidelity of the data read from a particular group of memory cells to the data written to that group of memory cells. The device 100 may include a number of different ECC control circuits 120, each of which is responsible for a different portion of the memory cells MC of the memory array 118. For example, there may be one or more ECC control circuits 120 for each bank of the memory array 118.

Each ECC control circuit 120 may receive a codeword which includes a certain number of data bits and a certain number of parity bits (e.g., 128 data bits and 8 parity bits). The data bits may be provided from either from the IO circuit 122 or the memory array 118 depending on if it is a read or write operation, and the ECC control circuit 120 uses the parity bits to locate and correct potential errors in the codeword. For example, as part of a write operation an ECC control circuit 120 may receive 128 bits of data from the IO circuit 122 and may generate 8 parity bits based on those 128 data bits to form a codeword with 136 total bits. The codeword may be written to the memory array 118. As part of an example read operation, the ECC control circuit 120 may receive a codeword with 128 data bits and 8 parity bits from the memory cell array 118. The ECC control circuit 120 may generate new parity bits from the 128 data bits, and then compare the new parity bits to the read parity bits in the codeword to generate syndrome bits. The syndrome bits may be used to locate errors in the codeword and the ECC control circuit 120 and may correct them if any are found before supplying the data bits to the IO circuit 122. While various embodiments may be discussed with reference to ECC circuits which use codewords where 8 parity bits are used to find one error in 128 data bits, it should be understood that these are for explanatory purposes only, and that other numbers of data bits, error bits, and parity bits may be used in other example embodiments.

During a read operation, the ECC control circuit 120 checks the codeword and locates and corrects any errors before providing the corrected codeword to the IO circuit 122. Accordingly, if there was an error, it may remain in the codeword stored in the memory array 118, since the correction is made between the memory array 118 and the IO circuit 122. The memory device 100 includes error check and scrub (ECS) logic 130, which is used to correct errors stored within the memory array 118. Over the course of an ECS cycle, the ECS circuit 130 generates a sequence of ECS addresses ECS_ADD which cover all the codewords stored in the memory array 118. The ECS addresses ECS_ADD include row, column, and bank addresses in order to specify a codeword. For each ECS address in the sequence, the ECS circuit 130 operates the address decoder 104 and command decoder 106 to perform a read operation on the memory cells which store the codeword associated with the ECS address, such that the codeword is read out to the ECC circuit 120 and corrected, and then instead of providing the corrected codeword off the device 100 as in a normal read, the corrected codeword is written back to the memory array 118 to the original location specified by the ECS address. In some embodiments, only a portion of the codeword (e.g., only the data bits or only the data bit changed by the correction) may be written back to overwrite the previous codeword. By cycling through a sequence of addresses which includes all codewords, the ECS circuit 130 may perform an ECS cycle to repair the errors in the memory cells array 118.

The memory may receive ECS commands ECS_cmd, such as manual ECS (MECS) commands along the C/A terminals. The command decoder 106 provides the ECS_cmd to the ECS logic 130, which performs one or more ECS operations (e.g., on one or more codewords) responsive to the ECS command. The number of ECS operations may be based on an ECS state logic circuit 134 of the ECS logic 130 and an ECS size setting ECS_size stored in a settings register 132. The settings register 132 may be a mode register of the device 100 or a fuse register. In some embodiments, the memory 100 may be capable of performing an ECS operation on a first bank and performing a different operation (e.g., a read operation, a write operation, a refresh operation, etc.) on a different bank.

The ECS cycle (e.g., an ECS operation on each codeword in the device 100) may generally be performed over a set amount of time, for example 24 hours. The controller sends ECS commands at a rate such that all of the codewords are refreshed over the course of the ECS cycle. For example, if there are A codewords, and the default assumption is that one codeword is refreshed per ECS command, and the ECS cycle is B units of time long, then the controller will send ECS commands at an average rate of A/B. However, different devices have different numbers of codewords. In a conventional device, this may require the controller to adjust the average rate of ECS commands. In a device of the present disclosure, the controller provides ECS commands at a steady rate, and the memory device 100 adjusts the number of ECS operations performed per ECS command to keep the overall ECS cycle length steady.

The ECS_size setting may be set based on a number of codewords in the device. The ECS_size setting may act as a multiplier to determine how many ECS operations are performed for each received ECS command. For example, if the rate of ECS commands is set based on a part with X codewords, then for a part with X codewords, the ECS_size setting may cause 1 ECS operation per ECS command. For a part with 2X codewords, the ECS_size setting may cause 2 ECS operations per ECS command.

In some embodiments, the controller (not shown in FIG. 1) may influence all or part of where the ECS operation is performed instead of or in combination with the ECS address logic of the ECS logic circuit 130. For example, in some embodiments, the ECS command may include one or more pieces of information about the ECS address such as all or a portion of the bank address, all or a portion of the row address, all or a portion of the column address, or combinations thereof. In some embodiments, the ECS address may be stored in a mode register (e.g., settings register 132). The controller may perform a mode register write operation to change the ECS address in the mode register 132, and thus change where the next ECS operation is performed.

The device 100 may also receive commands causing it to carry out one or more refresh operations as part of a self-refresh mode. In some embodiments, the self-refresh mode command may be externally issued to the memory device 100. In some embodiments, the self-refresh mode command may be periodically generated by a component of the device. In some embodiments, when an external signal indicates a self-refresh entry command, the refresh signal AREF may also be activated. The refresh signal AREF may be a pulse signal which is activated when the command decoder 106 receives a signal which indicates entry to the self-refresh mode. The refresh signal AREF may be activated once immediately after command input, and thereafter may be cyclically activated at desired internal timing. The refresh signal AREF may be used to control the timing of refresh operations during the self-refresh mode. Thus, refresh operations may continue automatically. A self-refresh exit command may cause the automatic activation of the refresh signal AREF to stop and return to an IDLE state. The refresh signal AREF is supplied to the refresh control circuit 116. The refresh control circuit 116 supplies a refresh row address RXADD to the row decoder 108, which may refresh one or more wordlines WL indicated by the refresh row address RXADD.

The power supply terminals are supplied with power supply potentials VDD and VSS. The power supply potentials VDD and VSS are supplied to an internal voltage generator circuit 124. The internal voltage generator circuit 124 generates various internal potentials VPP, VOD, VARY, VPERI, and the like based on the power supply potentials VDD and VSS supplied to the power supply terminals. The internal potential VPP is mainly used in the row decoder 108, the internal potentials VOD and VARY are mainly used in the sense amplifiers SAMP included in the memory array 118, and the internal potential VPERI is used in many peripheral circuit blocks.

The power supply terminals are also supplied with power supply potentials VDDQ and VSSQ. The power supply potentials VDDQ and VSSQ are supplied to the input/output circuit 122. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

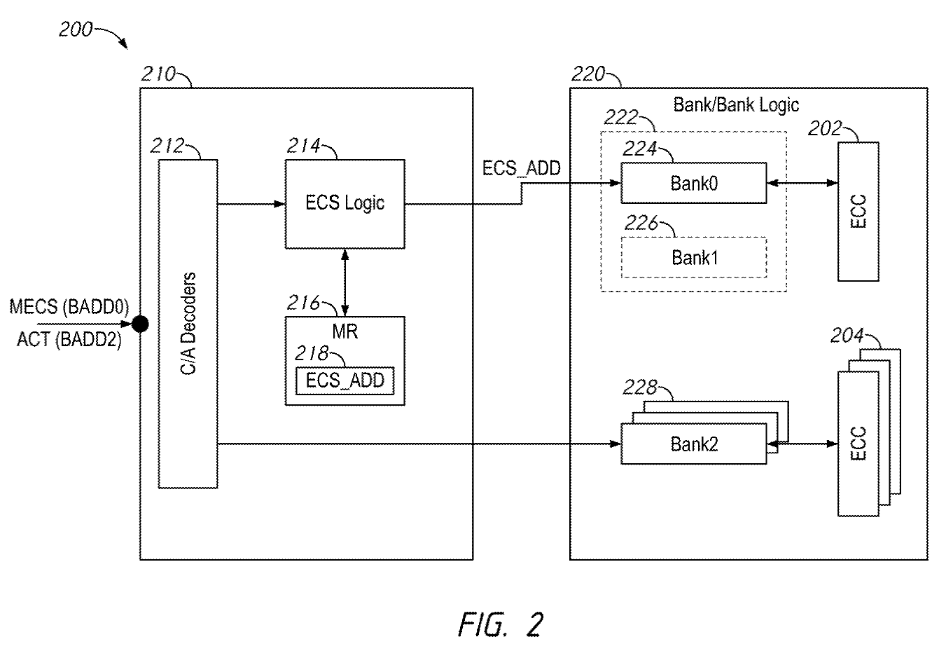

FIG. 2 is a block diagram of bank access logic circuits in a memory device according to some embodiments of the present disclosure. The bank access logic circuits 200 may be included in the memory device 100 of FIG. 1 in some embodiments. The bank access logic circuits 200 of FIG. 2 shows how the memory device may perform ECS operations on one bank 224 while performing other operations on one or more other banks 228.

The bank access logic circuits 200 include a central portion 210 and a bank region 220. The central portion 210 represents circuits which are generally common among the banks. The central portions 210 includes C/A decoders 212 (e.g., one or more of C/A input circuit 102 of FIG. 1, address decoder 104 of FIG. 1, command decoder 106 of FIG. 1, or combinations thereof), an ECS logic circuit 214 (e.g., 130 of FIG. 1), and a mode register 216 (e.g., 132 of FIG. 1).

The bank region 220 shows the memory banks (e.g., 118 of FIG. 1) and ECC circuits (e.g., 120 of FIG. 1) associated therewith. In the example of FIG. 2, a targeted bank 224 is shown. The targeted bank 224 is the bank where the ECS command is directed. The targeted bank 224 is part of a bank group 222 which includes a second bank 226. The two banks 224 and 226 of the bank group 222 share a common ECC circuit 202. Other banks 228 are also shown, along with their respective ECC circuits 204. Other numbers of banks per bank group may be used in other example implementations. In some embodiments, each bank may have an individual ECC circuit.

In the example embodiment of FIG. 2, the memory performs ECS operations on a bank 224 specified by the ECS command received from the controller. In some embodiments, the memory may receive an ECS command (e.g., MECS) which includes a bank address along one or more C/A terminals of the memory. In some embodiments, the controller writes the bank address to a mode register 216 to control where the ECS operation will be performed.

In some embodiments, the mode register 216 includes an ECS address register ECS_ADD 218. The value ECS_ADD indicates where the ECS operation will be performed. In some embodiments, the ECS logic circuit 214 generates the address and writes it as ECS_ADD 218 to the mode register 216. In some embodiments the controller may perform a mode register read operation on the register 218 to determine the value of ECS_ADD. In some embodiments, the value ECS_ADD 218 in the register 216 is used to determine where the next ECS operation will be performed. For example, the value ECS_ADD may be read by the ECS logic circuit 214 and updated to generate the next ECS_ADD. In some embodiments, the register 218 may be a read/write register, and the controller may perform a mode register write operation to change the value of ECS_ADD and thus change where the next ECS operation will be performed.

After an ECS operation is commanded in a first bank 224, in this example Bank0, the memory may receive a command for a different bank, in this example Bank2. For example, the memory may receive a row activation command ACT, which includes a bank address BADD for Bank2. Bank2 is one of the additional banks 228 which do not share the ECC circuit 202. Since the controller knows that an ECS operation is being performed on Bank0, either by directly controlling which bank the ECS operation is being performed on or by determining where the ECS operation is being performed such as by checking the address register 218, it knows which other banks 228 are available for operations.

In some embodiments, the bank 224 where the ECS operation is being performed may cause one or more other banks 226 to be unavailable for commands. For example, if multiple banks share an ECC circuit, such as banks 224 and 226 sharing ECC circuit 202, then those banks will also be unavailable while one of them is performing an ECS operation. In the example of FIG. 2, pairs of banks share an ECC circuit, and so when Bank0 224 is performing an ECS operation, Bank1 is unavailable 226. The controller may account for this when determining where to perform other access operations. For example, the controller may include logic which determines that when an ECS operation is performed on Bank0 224, then an access command cannot be sent to Bank1 226 until the ECS operation on Bank0 224 is finished.

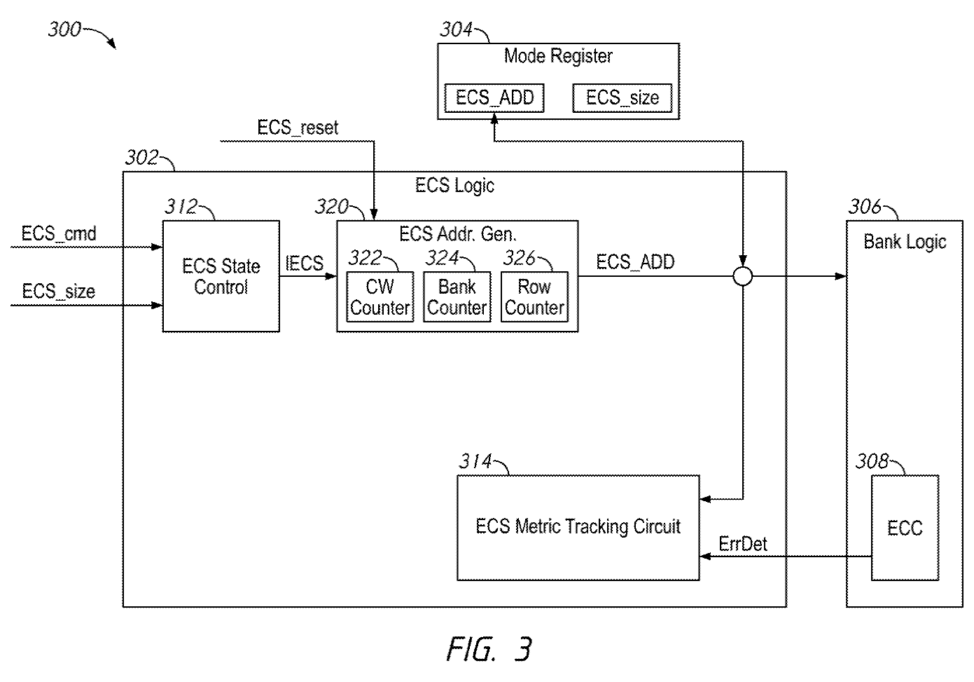

FIG. 3 is a block diagram of ECS logic circuits according to some embodiments of the present disclosure. The ECS logic circuits 302 may implement the ECS logic 130 of FIG. 1 and/or 214 of FIG. 2 in some embodiments. The ECS logic 302 of FIG. 3 receives an ECS command ECS_cmd (e.g., MECS) and performs one or more ECS operations by providing a number of ECS addresses ECS_ADD to the bank logic 306 (e.g., 118 of FIG. 1). The number of ECS operations performed is based on the ECS size setting ECS_size from a settings register (e.g., a mode register and/or fuse array).

The ECS logic 302 includes an ECS state control circuit 312 which provides one or more activations of an internal ECS signal IECS to an ECS address generator circuit 320. The ECS generator circuit 320 generates an ECS address ECS_ADD for each ECS operation based on the number of activations of IECS. Also shown in FIG. 3 is a mode register 304 (e.g., 132 of FIG. 1 and/or 216 of FIG. 2), bank logic 306 (e.g., 220 of FIG. 2) which includes the banks themselves as well as various logic circuits associated with those banks such as the ECC circuits 308 and row and column decoders (e.g., 108 and 110 of FIG. 1) not shown in FIG. 3.

The ECS state control circuit 312 generates different numbers of activations of IECS based on the setting ECS_size. In some embodiments, the setting ECS_size may act as a multiplier giving the number of ECS operations to perform per ECS cycle. In some embodiments, the ECS state control circuit 312 changes the number of activations of IECS for each command ECS_cmd. For example, if the value of ECS_size is 3, then for each ECS_cmd, the ECS state control circuit 312 provides 3 activations of IECS. In some embodiments, the ECS state control circuit 312 may generate different numbers of IECS activations to different ECS commands. For example, if the ECS size setting is 1.5, then the ECS state control circuit 312 may provide 2 activations of IECS for some ECS commands and 1 activation of IECS for other ECS commands.

In some embodiments, the value ECS_size may be stored in a register of the mode register 304. In some embodiments, the value ECS_size may come along with the ECS_cmd. For example, one or more bits of the ECS_cmd command packet may specify the value of ECS_cmd for that command.

The ECS address generator circuit 320 generates an ECS address ECS_ADD responsive to an activation of IECS. The ECS generator circuit 320 includes counter circuits 322, 324, and 326 to generate the ECS address ECS_ADD. For example, the ECS address generator circuit 320 includes a code word counter 322, a bank counter 324, and a row counter 326. The bank counter 324 is used to generate the bank address portion of ECS_ADD, the codeword counter 322 is used to generate the column address portion of ECS_ADD, and the row counter 326 is used to generate the row address portion of ECS_ADD.

The counters 322-326 of the ECS address generator 320 may be sequential. When a previous counter wraps, and rolls from a maximum value back to an initial value, a next counter is updated (e.g., incremented). The first counter in the sequence is updated (e.g. incremented) for each ECS operation, for example responsive to each activation of IECS. In some example embodiments, the ECS address generators may be ordered from code word counter 322 to bank counter 324, to row counter 326. For example, responsive to IECS, the code word counter 322, and thus the column address, are updated. If the code word counter 322 has reached a maximum value (e.g., the last column address along a row), the bank counter 324 is updated. Once the bank counter 324 wraps, the row counter 326 updates. In this manner, each codeword along a first row in a first bank may have an ECS operation performed on it, then each codeword along the first row in a second bank and so forth until the last codeword on the first row in the last bank has an ECS operation performed on it, then the cycle may repeat starting with the first codeword on a second row in the first bank.

In some embodiments, the ECS address generator 320 may use more complicated logic to shift which counter updates. For example, instead of waiting for a first counter to wrap before updating a next counter, the ECS address generator 320 may separate the counters into portions and update a subsequent counter when the first portion completes. For example, the codeword counter 322 may be divided into a first address range and a second address range. When the codeword counter 322 is on the last address of the first address range, when IECS is next received instead of the codeword counter 322 updating, the bank counter 324 updates. When the bank counter 324 wraps, instead of the row counter updating, the codeword counter 322 switches to addresses of the second range. Once the bank counter 324 wraps again, the row counter 326 updates.

In some example embodiments, the ECS command may specify all or a portion of the ECS address. When the ECS command specifies all of the ECS address, the ECS logic circuits 302 perform an ECS operation on the codeword specified by the address. When the ECS command specifies a portion of the ECS address, the ECS address generator circuit 320 may generate the remaining portions of the ECS address. For example, if the ECS command specifies the bank address, then the ECS address generator will skip using the bank counter 324, but will still use the code word counter 322 and the row counter 326 to generate the ECS address. When the ECS command does not specify any of the address, then the ECS address generator 320 generate the entirety of the address.

In some embodiments, one or more registers of the mode register 304 may be used to store the ECS address. For example, when the ECS address generator circuit 320 provides an ECS address ECS_ADD, it may be written to the mode register 304. A controller of the memory may perform mode register read operations to determine the ECS address from the mode register 304. For example, the controller may read the ECS_ADD from the mode register 304 in order to determine which bank the ECS operation is being performed on, so that the controller knows which other bank(s) are available for commands during the ECS operation.

In some embodiments, the ECS address register in the mode register 304 may be a read/write register, and the controller may perform a mode register write operation to write an ECS address to the mode register. This written address may then be used as the ECS address for the next ECS operation. In some embodiments, the memory may receive an ECS address reset command ECS_reset, e.g., via the C/A bus or through a register of the mode register. The ECS_reset command causes the ECS logic circuit 302 to reset one or more of the counters 322, 324, or 326 in the ECS address generator circuit 320. The reset command ECS_reset may cause the ECS address generator 320 to re-initialize one or more of the counters 322, 324, or 326 with the corresponding address value in the ECS address register of the mode register 304 in some embodiments.

In an example operation, the controller may write a bank address to the ECS address register ECS_ADD in the mode register 304. This new bank address overwrites the previous value of the bank address stored in the register. The controller then sends an ECS reset command ECS_reset. This causes the ECS address generator circuit 320 to reset the current value of the counters 322, 324, and 326 to the values in the ECS register. Since the controller did not overwrite the column or row address, the code word counter 322 and row counter 326 maintain their values. But since a new bank address was written, the ECS address generator 320 sets the bank counter 324 to the new value. When ECS operations resume, the ECS address generator 320 will begin generating addresses based on the new value of the bank address. In this way, the controller may use mode register write operations and ECS reset commands in order to ‘jump’ the ECS operations to a new location in the sequence.

The ECS logic circuit 302 includes an ECS metric tracking circuit 314 that records various metrics about the memory’s performance based on the errors detected during ECS operations. The ECS metric tracking circuit 314 receives an error detected signal ErrDet from the ECC circuit 308 when the ECC circuit 308 detects an error in the codeword during an ECS operation. The ECS metric tracking circuit 308 tracks information like the total number of errors counted (EC), the row address (from the ECS_ADD) and number of errors along the row with the highest errors in an errors per row count (EpRC), or both.

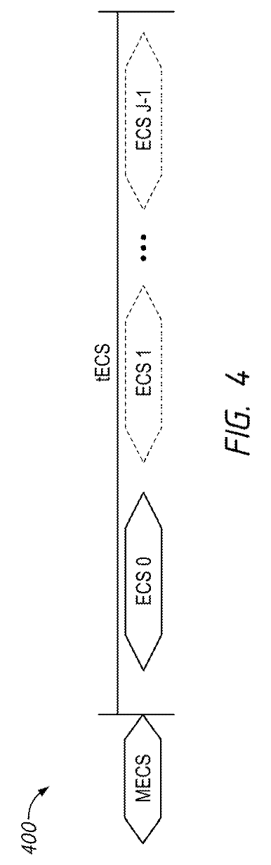

FIG. 4 is a timing diagram of ECS operations according to some embodiments of the present disclosure. The timing diagram 400 of FIG. 4 may represent an ECS command and ECS operations performed by a memory device such as 100 of FIG. 1 and/or an ECS logic circuit such as 214 of FIG. 2, 302 of FIG. 3, or combinations thereof. The timing diagram 400 represents one or more ECS operations being performed responsive to an ECS command ECS_cmd.

When the memory receives an ECS command such as MECS, the memory has a timing window tECS during which it can perform ECS operations. During the timer period tECS, the bank where the ECS operation is being performed cannot receive other commands. Accordingly, after sending an ECS command, the controller will wait at least tECS before sending a subsequent command to the bank where the ECS operation is being performed. In some embodiments, other banks may be still be accessed during this time. In some embodiments, as well as the bank where the ECS operation is being performed, one or more other banks (e.g., 226 of FIG. 2) may also be restricted from performing operations.

In some embodiments, the time tECS may be fixed and may be based, in part, on a maximum number of ECS operations that may need to be performed responsive to the ECS command. For example, if the highest setting of ECS_size (e.g., based on the largest number of code words on the parts which share the same ECS command rate) calls for 8 ECS operations per ECS command, then the total length of tECS may be set based on how long it takes for 8 ECS operations to be performed.

In some embodiments, the length of tECS may be variable based on the ECS_size setting. For example, if the ECS_size setting calls for relatively few ECS operations per ECS command, then tECS may be shorter than if the ECS_size setting calls for more ECS operations per ECS command. The controller may determine the value of ECS_size and then use that to set a value of tECS, which in turn determines how quickly the controller provides a subsequent commands to the bank(s) which are restricted during tECS after an ECS command.

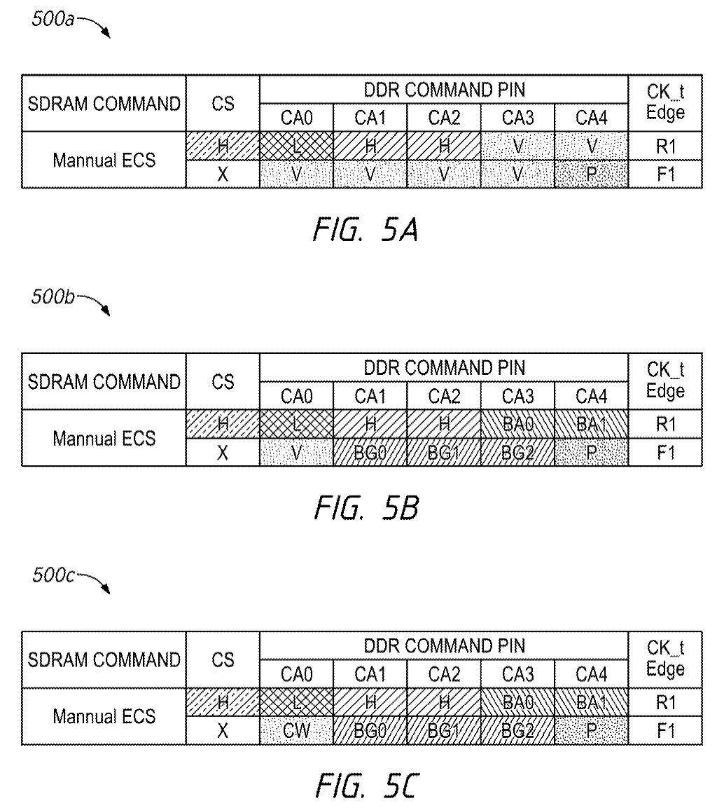

FIGS. 5A-5C are charts showing example ECS commands according to some embodiments of the present disclosure. Each of the charts 500a, 500b, and 500c of FIGS. 5A-5C respectively show different example commands that may be used as any of the ECS commands (e.g., MECS or ECS_cmd of any of FIGS. 1-4) described herein, such as in the memory device 100 of FIG. 1, the bank access logic circuits 200 of FIG. 2, and/or the ECS logic circuit 300 of FIG. 3.

Each of the charts 500a, 500b, and 500c represent signals along C/A terminals of a memory device. Each chart shows signals along five C/A terminals CA0 to CA4 on both rising (R1) and falling (F1) edges of a system clock. Each of the charts 500a, 500b, and 500c shows a table representing the values which are used to represent the ECS command and what information comes along with that command. For example, a table entry of H represents a logical high value, an L represents a logical low value, while V and P represent system values (e.g., bits that are unused as part of that command packet). Other labels may be used to represent what information is encoded in that bit.

The chart 500a of FIG. 5A shows an example where the ECS command does not include address information or specify a number of ECS operations to be performed. Instead, the memory may determine such information. The chart 500b of FIG. 5B shows an example where the ECS command include bank address information. Specifically, 5 of the bits are used to represent the bank address information. On the rising clock edge the bits on pins CA3 and CA4 encode two bank address bits BA0 and BA1 respectively, and on the falling edge the pins CA1, CA2, and CA3 encode bank group address bits BG0, BG1, and BG2 respectively.

The chart 500c of FIG. 5C shows an example where the ECS command contains both bank address information and a bit, CW, which specifies how many ECS operations to perform responsive to this ECS command. The chart 500c includes the same bank address information as the chart 500b. In addition, the bit on pin CA0 on the falling edge of the clock specifies the value of CW. In this example implementation, the MECS command may specify a first or second number of code words to have ECS operations performed on them per command. If additional bits are used, then other numbers of ECS operation per command may be specified.

Other example ECS commands could include other information, such as row or column address information, or could use other numbers of bits to specify the different information such as the number of ECS operations per ECS command or the address information.

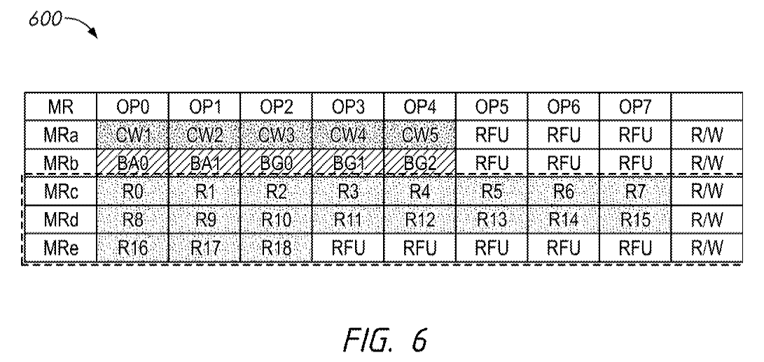

FIG. 6 is a chart of a mode register including ECS address information according to some embodiments of the present disclosure. The mode register 600 of FIG. 6 may be included in a memory device such as one or more of the memory devices of FIGS. 1-3 described herein. For example, the mode register 600 may implement the mode register 132 of FIG. 1, 216 of FIG. 2, and/or 304 of FIG. 3. The mode register 600 includes ECS address information. In the example of FIG. 6, five registers MRa to MRe are shown, each of which has eight OP codes OP0 to OP7, which store information. The chart 600 shows an example organization of a mode register, other organizations may be used in other example embodiments.

In the example of FIG. 6, the register MRa includes the ECS_size setting (e.g., ECS_size). The register MRb includes bank address information of the most recent ECS address. The registers MRc to MRe include row address information.

In some embodiments, the bank address information (e.g., in register MRb) may be eliminated, for example in embodiments where the ECS command specifies a bank address. In some embodiments, the row address information (e.g., MRc to MRe) may be eliminated.

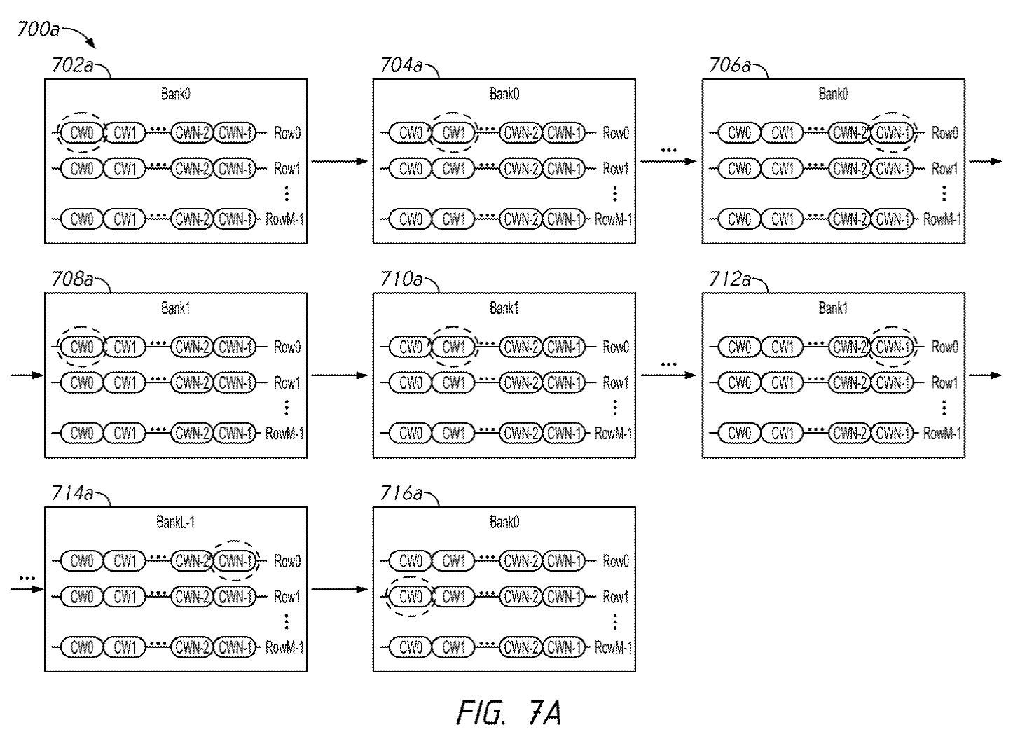

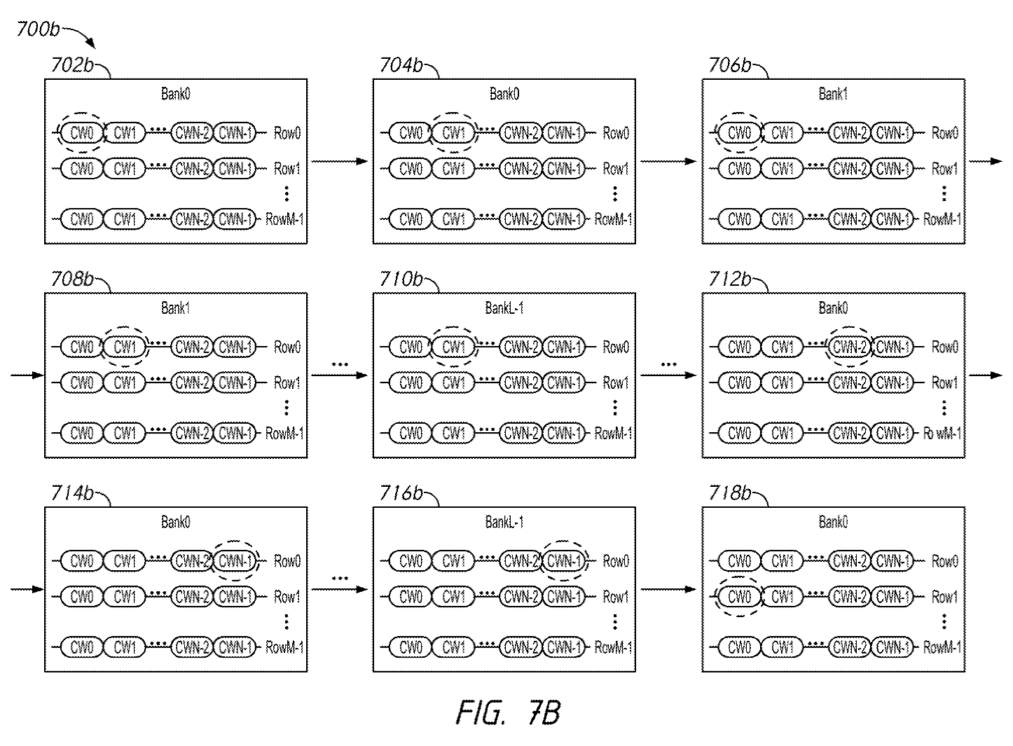

FIGS. 7A and 7B are example sequences of ECS operations according to some embodiments of the present disclosure. The sequence may be implemented by the memory device such as 100 of FIG. 1 and/or an ECS logic circuit such as 214 of FIG. 2 or 300 of FIG. 3. The example sequences 700a of FIG. 7A and 700b of FIG. 7B shows how ECS operations proceed through an example memory device during an example ECS cycle.

The sequences of FIGS. 7A and 7B are represented by a sequence of boxes, each of which represents the location where an ECS operation is performed. Each box 702a-716a in FIG. 7A and 702b-718b in FIG. 7B shows a representation of a bank, with codewords represented as bubbles along a line which represents a word line. The codeword where the ECS operation is performed is circled. The example memory device includes L memory banks, each of which includes M rows, each with N codewords along them. Both sequences 700a and 700b are initialized starting with an ECS operation on a first codeword (CW0) along a first row (Row0) in a first bank (Bank0).

If a single ECS operation is performed for each ECS command, then each box may represent an ECS command. If multiple ECS operations are performed, then multiple steps of the sequence may be performed for each ECS operation. In embodiments where the controller has an ability to change where the ECS operation is being performed (e.g., by providing address information with the ECS command) then steps may be performed out of sequence. In embodiments where the controller can change the state of the sequence (e.g., by resetting one or more of the ECS address counters to a written value in the mode register) then the sequence may jump to another point in the sequence rather than proceeding to the next step.

FIG. 7A shows an example embodiment where all the code words along a row have an ECS operation performed along them, then the bank counter updates. Once all the banks have had ECS operations performed on them, then the row address updates. This repeats until all codewords have had an ECS operation performed on them, and then the cycle repeats. For example, the ECS address counters may operate in order from code word counter (e.g., 322 of FIG. 3) to bank counter (e.g., 324 of FIG. 3) to row counter (e.g., 326 of FIG. 3).

The sequence 700a begins with box 702a which shows an ECS operation being performed on a first codeword CW0 along a first row Row0 in a first bank Bank0. The next box 704a shows a next ECS operation on CW1 on Row0 in Bank0. The box 706a is several ECS operations later and shows an ECS operation on the final codeword CWN-1 on Row0 in Bank0. Box 708a shows the next ECS operation after the one in box 706a, where an ECS operation is performed on CW0 of Row0 of a next bank, Bank1. Box 710a shows the next ECS operation after box 708a, where an ECS operation is performed on CW1 of Row0 of Bank1. After several more ECS operations box 712a occurs which shows an ECS operation on the last codeword CWN-1 of Row0 of Bank1. Box 714a is many ECS operations after box 712a. In box 714a, an ECS operation is performed on the last codeword CWN-1 of the first row Row0 in the last bank BankL-1. The next ECS operation, in box 716a, shows an ECS operation in the first bank Bank0 on the first codeword CW0 of the second row Row1.

FIG. 7B shows a sequence 700b of an example embodiment where a portion of the code words along a row have ECS operations performed on them, then the bank is iterated, and once that portion in each bank has had ECS operations performed on them, the remainder of the codewords along the first row in the first bank have ECS operations performed on them, and then after the remainder has ECS performed on it the row updated. For example, the ECS code word counter may be split into two portions and the counters may operate in order from code word (first portion) to bank to code word (second portion) to row.

Box 702b shows the first ECS operation being performed on Bank0, Row0, CW0. Box 704b shows the next ECS operation on CW1 of Bank0 and Row0. In this example implementation, the first portion of codewords is just CW0 and CW1. Other example implementations may divide the codewords into portions differently (e.g., a first half and a second half). Since CW1 is the last address of the first CW address range portion, at box 706b, which shows the next ECS operation after box 704b, an ECS operation is performed on CW0 of Row0 of the next bank, Bank1. Box 708b shows a next ECS operation where CW1 of Row0 of Bank1 has an ECS operation performed on it. After many more ECS operation, Box 710b shows an ECS operation on the last codeword of the first range, CW1 on Row0 of the last bank BankL-1. The next ECS operation (not shown) would be on CW2 of Row0 of Bank0 and after several more ECS operations box 712b shows an ECS operation CWN-2 of Row0 of Bank0 and then box 714b shows CWN-1 of Row0 of Bank0. Several ECS operations later, box 716b shows an ECS operation on the last codeword CWN-1 of Row0 of the last bank BankL-1. The next ECS operation, shown in box 718b, will be on Row1 of Bank0, but back in the first range of CW addresses in CW0.

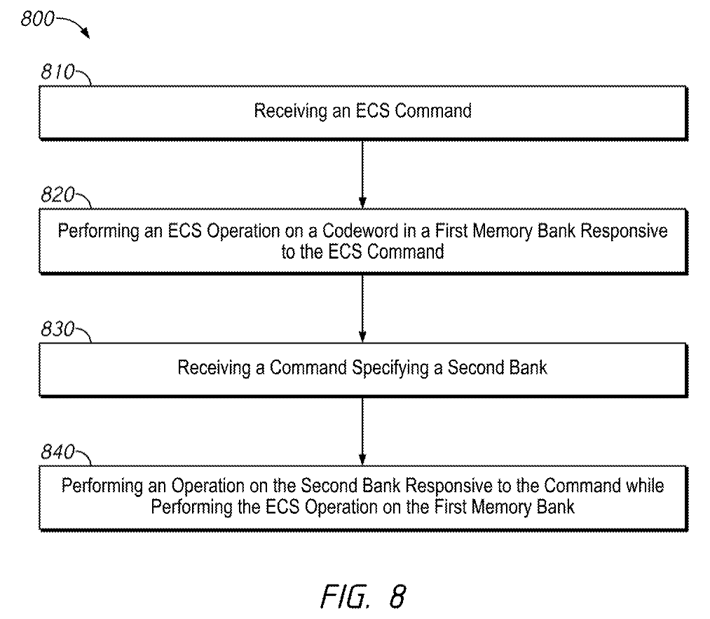

FIG. 8 is a flow chart of a method of performing operations on a memory while performing ECS operations according to some embodiments of the present disclosure. The method 800 may be implemented by one or more of the systems, apparatuses, or portions thereof, described herein. For example, the method 800 may be performed by the memory device 100 of FIG. 1, the bank access logic 200 of FIG. 2, and/or the ECS logic 300 of FIG. 3 in some embodiments.

The method 800 begins with box 810 which describes receiving an ECS command. In some embodiments, the ECS command may include address information, such as a bank address, row address, column address, or combinations thereof. The method 800 may include receiving the ECS command along C/A terminals of the device (e.g., commands 500a-500c of FIGS. 5A-5C). In some embodiments, the method 800 may include an ECS size setting along with the ECS command.

Box 810 may generally be followed with box 820 which describes performing an ECS operation on a codeword in a first memory bank responsive to the ECS command. Performing the ECS operation may include reading the codeword to an ECC circuit (e.g., 120 of FIG. 1, 202 of FIG. 2, and/or 308 of FIG. 3) determining if there is an error in that codeword, correcting the error if so, and then writing the corrected codeword (or just the corrected portion) back to the original location in the array. In some embodiments, the method 800 may include performing a plurality of ECS operations responsive to the ECS command. The number of ECS operations may be based on an ECS size setting, which may be received along with the ECS command or saved in a settings register such as a fuse array or a mode register.

Box 820 may generally be followed by box 830, which describes receiving a command specifying a second bank (e.g., 228 of FIG. 2). The command may be an access command, a refresh command, or another type of command. Box 830 may generally be followed by box 840, which describes performing an operation on the second bank responsive to the command while performing the ECS operation on the first memory bank. The method 800 may include blocking commands to the first bank for a length of time tECS. The method 800 may also include blocking commands to another bank (e.g., 226 of FIG. 2) for the time tECS. In some embodiments, the method 800 may include setting a length of tECS based on the maximum number of ECS operations that can be performed responsive to one ECS command.

In some embodiments, the method 800 may include performing a mode register write operation to write all or part of an ECS address to an ECS address register of the memory device and selecting the codeword based on the ECS address in the ECS address register. In some embodiments, the method may include resetting address counters in the ECS circuit to match the ECS address in the mode register. For example, the method 800 may include receiving an ECS reset command changing the state of one or more ECS address counters to match the values in the ECS address register.

In some embodiments, the method 800 may include generating an ECS address, such as with an ECS address generator circuit (e.g., 320 of FIG. 3). In some embodiments, the ECS address may include a bank address, a column address, and a row address. In some embodiments, the method 800 may include receiving all or a portion of the ECS address along with the ECS command and generating a remaining portion of the ECS address with the ECS address generator circuit.

In some embodiments, the method 800 may include updating a codeword counter (e.g., 322 of FIG. 3) responsive to the ECS command to generate the column address, updating a bank address counter (e.g., 324 of FIG. 3) when the codeword counter wraps to generate the bank address, and updating a row address counter (e.g., 326 of FIG. 3) when the bank counter wraps to generate the row address. In some embodiments, the method 800 may include updating the codeword counter until it reaches an end of a first range of values, then updating the bank counter, then returning to updating the codeword counter within the first range. Once the bank counter wraps, the codeword counter switches to a second range of values and begins updating within the second range. When the codeword counter reaches an end of the second range of values, the bank counter updates and the codeword counter returns to a beginning of the second range of values. Once the bank counter wraps a second time, the row counter wraps and then the codeword counter returns to the first range of values.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a memory array configured to store a plurality of code words; and
an error correct and scrub (ECS) circuit configured to perform an ECS operation on a selected code word of the memory array responsive to an ECS command, wherein the ECS command includes address information comprising a bank address, a row address, a column address or combinations thereof, and wherein the ECS circuit is configured to select the selected one of the plurality of codewords for the ECS operation based, in part, on the address information.

2. The apparatus of claim 1, further comprising:
a settings register configured to store a size setting based on an amount of the plurality of codewords, wherein the ECS circuit is configured to perform a number of ECS operations responsive to the ECS command, and wherein the number of ECS operations performed is based on the size setting.

3. The apparatus of claim 1, wherein the ECS command specifies a number of ECS operations to be performed responsive to the ECS command.

4. The apparatus of claim 1, wherein the ECS circuit comprises an ECS address generator circuit configured to generate the bank address, the row address, the column address, or combinations thereof if they are not specified by the address information.

5. The apparatus of claim 4, wherein the ECS address generator comprises:
a code word counter configured to generate the column address if the column address is not part of the address information;
a bank counter configured to generate the bank address if the bank address is not part of the address information; and
a row counter configured to generate the row address if the row address is not part of the address information,
wherein the code word counter is configured to update responsive to the ECS command, the bank counter is configured to update responsive to the code word counter wrapping, and the row counter is configured to update responsive to the bank counter wrapping.

6. The apparatus of claim 1, further comprising an error correction circuit configured to receive the selected one of the plurality of codewords, determine if there is an error in the selected one of the plurality of codewords, correct the error, and write the corrected codeword back to the memory array as part of the ECS operation.

7. The apparatus of claim 1, further comprising:
a command decoder configured to receive the ECS command and direct the ECS circuit to perform the ECS operation on a first bank of the memory array and configured to receive a command for a second bank of the memory array while the ECS operation is being performed on the first bank.

8. An apparatus comprising:
an error correct and scrub (ECS) circuit configured to generate an ECS address as part of an ECS operation;
a mode register configured to store the ECS address in an ECS address register; and
a memory array comprising a plurality of codewords,
wherein the ECS operation is performed on a selected one of the plurality of codewords, and wherein the selected one of the plurality of codewords is selected based on the ECS address in the ECS address register.

9. The apparatus of claim 8, wherein the ECS address register is a read/write register of the mode register.

10. The apparatus of claim 8, wherein the ECS circuit comprises:
a code word counter configured to update responsive to an ECS signal;
a bank counter configured to update when the code word counter wraps;
a row counter configured to update when the bank counter wraps,
wherein the ECS circuit is configured to generate the ECS address based on a state of the code word counter, the bank counter, the row counter, or combinations thereof.

11. The apparatus of claim 10, wherein responsive to an ECS reset signal, the ECS circuit is configured to set the state of the code word counter, the bank counter, the row counter, or combinations thereof to the ECS address stored in the ECS address register.

12. The apparatus of claim 8, wherein the ECS circuit is configured to perform a number of ECS operations responsive to an ECS command, wherein the number is based on an ECS size setting.

13. The apparatus of claim 12, wherein the ECS command includes the ECS size setting.

14. The apparatus of claim 12, wherein the mode register stores the ECS size setting.

15. A method comprising:
receiving an error correct and scrub (ECS) command;
performing an ECS operation on a codeword in a first bank responsive to the ECS command;
receiving a command specifying a second bank; and
performing an operation on the second bank responsive to the command while performing the ECS operation on the first memory bank.

16. The method of claim 15, wherein the ECS command includes address information specifying the first bank.

17. The method of claim 15, further comprising:
performing a mode register write operation to write an ECS address to a mode register; and
selecting the codeword for the ECS operation based on the ECS address.

18. The method of claim 15, further comprising:
performing a plurality of ECS operations each on a respective codeword responsive to the ECS command, wherein a number of the plurality of ECS operations is based on an ECS size setting.

19. The method of claim 15, further comprising:
generating an ECS address responsive to the ECS command, wherein the codeword is specified by the ECS address, wherein the generating includes:
updating a codeword counter to generate a column address responsive to the ECS command;
updating a bank counter to generate a bank address responsive to the codeword counter wrapping; and
updating a row counter to generate a row address responsive to the bank counter wrapping, wherein the ECS address comprises the column address, the bank address, and the bank address.

20. The method of claim 15, further comprising:
generating an ECS address responsive to the ECS command, wherein the codeword is specified by the ECS address, wherein the generating includes:
updating a codeword counter in a first range of values to generate a column address responsive to the ECS command;
updating a bank counter to generate a bank address responsive to the codeword counter reaching an end of the first range of values;
updating the codeword counter in a second range of values to generate the column address responsive to the ECS command after the bank counter has wrapped;
updating the bank counter to generate the bank address responsive to the codeword counter reading an end of the second range of values;
updating a row counter to generate a row address responsive to the bank counter wrapping, wherein the ECS address comprises the column address, the bank address, and the bank address.
